(19) United States
(12) Patent Application Publication
(10) Pub. No.: US 2024/0346378 A1
(43) Pub. Date: Oct. 17, 2024

(54) METHOD AND APPARATUS FOR INCREASING CUSTOMER ENGAGEMENT IN A SALES ENVIRONMENT

(71) Applicant: Optimy.ai; a division of Kognitive Tech Inc., Toronto (CA)

(72) Inventors: Joshua Singer, Toronto (CA); David Liu, Burlington (CA); Behnam Arjomandi, Oakville (ON)

(21) Appl. No.: 18/633,831

(22) Filed: Apr. 12, 2024

Related U.S. Application Data
(60) Provisional application No. 63/459,455, filed on Apr. 14, 2023.

(51) Int. Cl. G06N 20/00; G06Q 30/01

(52) U.S. Cl. CPC G06N 20/00; G06Q 30/01

(57) ABSTRACT

Various embodiments are described herein for a device and method for interacting with customers on e-commerce platforms. The various embodiments described herein generally relate to methods and apparatus for interacting with customers. In one embodiment, the system may be used in conjunction with e-commerce platforms, electronic document platforms, and any other electronic platforms. In other embodiments, the interaction with customers can be on electronic documents, portable document formats (PDFs), email and other forms of electronic platforms. On e-commerce platforms, customers can use electronic devices such as laptops, tablets, and mobile devices to browse products before deciding to make a purchase decision.

### CROSS-REFERENCE

This application claims the benefit of U.S. Provisional Patent Application No. 63/459,455 filed Apr. 14, 2023; the entire contents of which is hereby incorporated herein by reference in its entirety.

### FIELD

The various embodiments described herein generally relate to methods of interacting with customers on e-commerce platforms.

### BACKGROUND

During an in-person shopping experience, a customer can walk into a brick-and-mortar retail store to browse products before deciding to make a purchase decision. If the customer needs assistance with the purchase or shopping experience, they may decide to approach an agent, such as a sales associate, to request assistance with their purchase. On the other hand, if it seems that a customer is having difficulty making a purchase decision, the agent may also approach the customer to help the customer make the purchase decision, potentially resulting in increased sales.

On an e-commerce platform, customers can use electronic devices such as laptops, tablets, and mobile devices to browse products before deciding to make a purchase decision. However, if a customer requires assistance during the e-commerce shopping experience, it is often difficult to obtain an agent who can assist with the purchase.

As a result, e-commerce platforms typically provide access to online-agents via chat, voice-call or video call. However, the customer typically needs to approach the agent, rather than the agent approaching the customer. It is also quite difficult for online-agents to assess whether an online customer needs assistance with their purchase.

Furthermore, online-agents in some scenarios have been replaced by chatbots which can assist customers while shopping online and be available at any time of day. However, most of the chatbots available today are extremely limited in their capabilities and can only answer a limited number of questions asked by the customer. As a result, customers may leave the site frustrated, or without receiving the help they need to make a purchase, resulting in fewer sales for the e-commerce retailer.

Even when using chatbot agents, the customer typically needs to approach the bot, rather than the bot approaching the customer. It is also quite difficult for chatbots to assess whether an online customer needs assistance with their purchase. Furthermore, it may be difficult to assess which customer to approach as some customers may be browsing with no intent to make a purchase and others may be online-shopping with a strong intent to make a purchase.

In another example, the users may be using an e-commerce platform for filling out forms. In this instance, the user may have questions about filling out the form, and wish to be approached by an agent, yet an agent may not be readily available when the user needed them.

Improved systems are needed.

### SUMMARY OF VARIOUS EMBODIMENTS

In one aspect, a method of interacting with a customer on an e-commerce platform is provided herein. In at least one embodiment, the method comprises: providing, by a processor, a model to rank a plurality of messages based on a set of metrics; evaluating, by the processor, whether the customer would respond to one out of the plurality of messages; recommending, by the processor, at least one out of the plurality of messages that results in the highest probability of response from the customer; sending, by the processor, the recommended one out of the plurality of messages to the customer; determining, by the processor, a resulting action from the customer; and updating, by the processor, the set of metrics based on the resulting action to further train the model.

In at least one embodiment, the model is a machine learning model. In at least one embodiment, the set of metrics contains information about the e-commerce platform, information about the customer; and information about the customer browsing session. In at least one embodiment, the training of the machine learning model is completed using at least one of: inverse propensity-scoring algorithm; doubly robust algorithm; and importance weighted regression algorithm. In at least one embodiment, the method further comprises the step of amending at least one of the plurality of messages if the message receives a low probability of response from the customer.

In at least one embodiment, the plurality of messages comprises a text-based prompt; voice-based prompt; image based prompt; or video based prompt. In at least one embodiment, the set of metrics further comprises information about browsing behavior; recurrency; provenance; geolocation; and temporal details.

In at least one embodiment, the resulting action from the customer is a positive action such that the customer accepts the message. In at least one embodiment, the resulting action from the customer is a negative action such that the customer declines the message. In at least one embodiment, the resulting action from the customer is a neutral action such that the customer ignores the message.

In one aspect, an apparatus for interacting with a customer on an e-commerce platform is provided herein. In at least one embodiment, the apparatus comprises: a memory for storing instructions; and a processor configured to execute the instructions. In at least one embodiment, the processor can thereby cause the apparatus to at least: provide a model to rank a plurality of messages based on a set of metrics; evaluate and/or predict whether the customer would respond to one out of the plurality of messages; recommend at least one out of the plurality of messages that results in the highest probability of response from the customer; send, via an interface, the recommended one out of the plurality of messages to the customer; said interface being adapted to display the message; determine a resulting action from the customer; and update the set of metrics based on the resulting action to further train the model.

In at least one embodiment, the model is a machine learning model. In at least one embodiment, the set of metrics contains information about the e-commerce platform, information about the customer; and information about the customer browsing session.

In at least one embodiment, the training of the machine learning model is completed using at least one of: inverse propensity-scoring algorithm; doubly robust algorithm; and importance weighted regression algorithm. In at least one embodiment, the method further comprises the step of amending at least one of the plurality of messages if the message receives a low probability of response from the customer.

In at least one embodiment, the plurality of messages comprises a text-based prompt; voice-based prompt; image based prompt; or video based prompt. In at least one embodiment, the set of metrics further comprises information about browsing behavior; recurrency; provenance; geolocation; and temporal details.

In at least one embodiment, the resulting action from the customer is a positive action such that the customer accepts the message. In at least one embodiment, the resulting action from the customer is a negative action such that the customer declines the message. In at least one embodiment, the resulting action from the customer is a neutral action such that the customer ignores the message.

In one aspect, a method of interacting with a customer on an e-commerce platform is provided herein. In at least one embodiment, the method comprises: generating, by a processor, a plurality of messages based on a set of metrics associated with the customer; evaluating, by the processor, whether the customer would respond to one out of the plurality of messages; recommending, by the processor, at least one out of the plurality of messages that results in the highest probability of response from the customer; sending, by the processor, the recommended one out of the plurality of messages to the customer; evaluating, by the processor, a resulting action from the customer; logging a record of the resulting action into a memory; and updating, by the processor, the set of metrics based on the resulting action to further train the model.

In one aspect, in at least one embodiment described herein, there is provided a method of interacting with a customer on an e-commerce platform.

The method includes: training a machine learning model to rank a plurality of messages based on a set of metrics; the model evaluating and/or predicting whether the customer would respond to one out of the plurality of messages; the model recommending at least one out of the plurality of messages that results in the highest probability of response from the customer; the model sending the recommended one out of the plurality of messages to the customer; the model determining a resulting action from the customer; and the model updating the set of metrics based on the resulting action to further train the model.

In one embodiment, the set of metrics contains information about the e-commerce platform, information about the customer; and information about the customer browsing session. In one embodiment, the training of the machine learning model can be completed using at least one of: inverse propensity-scoring algorithm; doubly robust algorithm; contextual bandit algorithm; and importance weighted regression algorithm. In one embodiment, the method can further include the step of amending at least one of the plurality of messages if the message receives a low probability of response from the customer. In one embodiment, the plurality of messages can include a text-based prompt; voice-based prompt; image based prompt; or video based prompt. In one embodiment, the set of metrics can further include information about browsing behavior; recurrency; provenance; geolocation; and temporal details.

In one embodiment, the resulting action from the customer can be a positive action such that the customer accepts the message. In one embodiment, the resulting action from the customer can be a negative action such that the customer declines the message. In one embodiment, the resulting action from the customer can be a neutral action such that the customer ignores the message.

In another aspect, in at least one embodiment described herein, there is provided an apparatus. The apparatus can include a memory for storing instructions; and a processor configured to execute the instructions. The processor can cause the apparatus to at least: train a machine learning model to rank a plurality of messages based on a set of metrics; evaluate and/or predict whether the customer would respond to one out of the plurality of messages; recommend at least one out of the plurality of messages that results in the highest probability of response from the customer; send the recommended one out of the plurality of messages to the customer; determine a resulting action from the customer; and update the set of metrics based on the resulting action to further train the model.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 is a block diagram of a system for interacting with customers using a chatbot;

FIG. 2 is a block diagram of a machine learning apparatus in communication with a customer device;

FIG. 3A is a flowchart providing an example embodiment of a method of training a machine learning algorithm for interacting with customers using a chatbot;

FIG. 3B is a flowchart of an example method of interacting with customers using a chatbot, in accordance with an example embodiment;

FIG. 4 is a flowchart of an example method of interacting with customers using a chatbot, in accordance with an example embodiment;

FIG. 5 is a block diagram of the inputs of an example machine learning training model;

FIG. 6 is a system diagram of an example embodiment of the machine learning model;

FIG. 7 is a system diagram of another example embodiment of the machine learning model;

FIG. 8 is a table showing a set of measurable customer metrics that can be used as inputs to train the machine learning model;

FIG. 9 is a table showing a set of measurable customer metrics that can be used as inputs to train the machine learning model;

FIG. 10 is a table showing a set of sample initial prompts that can be used as inputs to train the machine learning model;

FIG. 11 is a table showing an example set of action features; and

FIG. 12 is a table showing a set of measurable rewards or outcomes from the customer.

### DETAILED DESCRIPTION OF THE EMBODIMENTS

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and a combination thereof. For instance, the system may also be implemented in nudge/call-to-action viewers of word documents, PDFs, emails or other forms of software.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer usable instructions may also be in various forms, including compiled and uncompiled code.

Various embodiments have been described herein by way of example only. Various modifications and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The various embodiments described herein generally relate to methods and apparatus for interacting with customers. In one embodiment, the system may be used in conjunction with e-commerce platforms, electronic document platforms, and any other electronic platforms. In other embodiments, the interaction with customers can be on electronic documents, portable document formats (PDFs), email and other forms of electronic platforms. On e-commerce platforms, customers can use electronic devices such as laptops, tablets, and mobile devices to browse products before deciding to make a purchase decision. However, if a customer requires assistance during the e-commerce shopping experience, it is often difficult to obtain an agent who can assist with the purchase. As a result, e-commerce platforms typically provide access to online-agents via chat, voice-call or video call; or to automated bots via chat (called chatbots). It is common for potential sales to be lost as e-commerce retailers typically have to wait for the customer to ask a question, or call the helpline before the retailers can offer assistance. Even when using chatbot agents, the customer typically needs to approach the bot when they need assistance, rather than the bot approaching the customer at an appropriate time, as it is quite difficult for chatbots and agents to assess whether an online customer needs assistance with their purchase.

In electronic document platforms, the customer may require assistance with filling out a form field or sending an email. In this instance, the chatbot agents or live agents may be able to assist the customer or user with filling the form.

The customer can engage with an e-commerce platform in a number of ways. For example, types of engagement can include, but are not limited to, filling out an electronic form, applying for a financial product, making a purchase, completing a purchase from the items already in your shopping cart, etc.

A method of interacting with a customer on an e-commerce platform is provided herein. The method includes: training a machine learning model to rank a plurality of messages based on a set of metrics; the model evaluating and/or predicting whether the customer would respond to one out of the plurality of messages; the model recommending at least one out of the plurality of messages that results in the highest probability of response from the customer; the model sending the recommended one out of the plurality of messages to the customer; the model determining a resulting action from the customer; and the model updating the set of metrics based on the resulting action to further train the model.

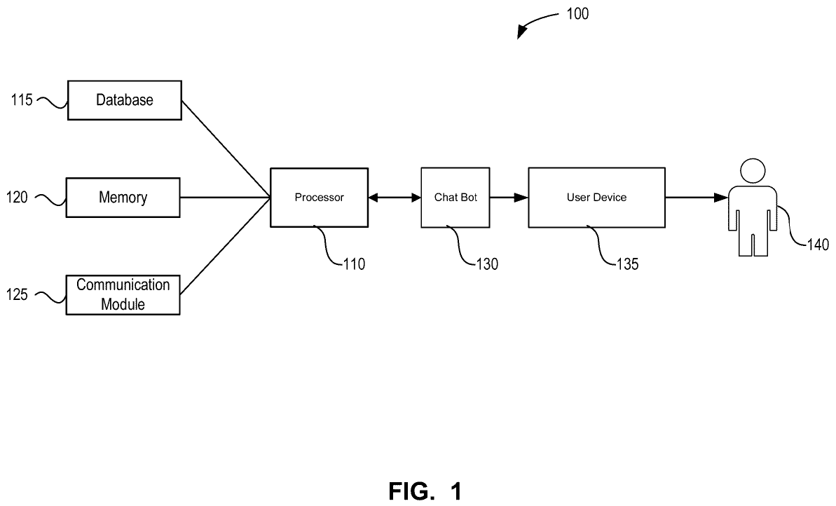

Turning now to the figures, FIG. 1 shows a block diagram of a system 100 for interacting with customers 140 using a chatbot 130. Processor 110 can include, and/or be in communication with database 115, memory 120 and communication module 125. The processor 110 can be configured to execute instructions stored in the memory 120. The processor 110 can thereby cause the system to: train a machine learning model to rank a plurality of messages based on a set of metrics; evaluate and/or predict whether the customer 140 would respond to one out of the plurality of messages; recommend at least one out of the plurality of messages that results in the highest probability of response from the customer 140; send the recommended one out of the plurality of messages to the customer 140; determine a resulting action from the customer 140; and update the set of metrics based on the resulting action to further train the model. The processor 110 can communicate with the customer 140 via a user device 135, through a chatbot 130. The plurality of messages can be displayed on the user device 135, and communicated through a nudge or via a chatbot 130. A nudge can be displayed in the form of a chat message, or as a standalone nudge such as a buzzing sound or visual cue nudge.

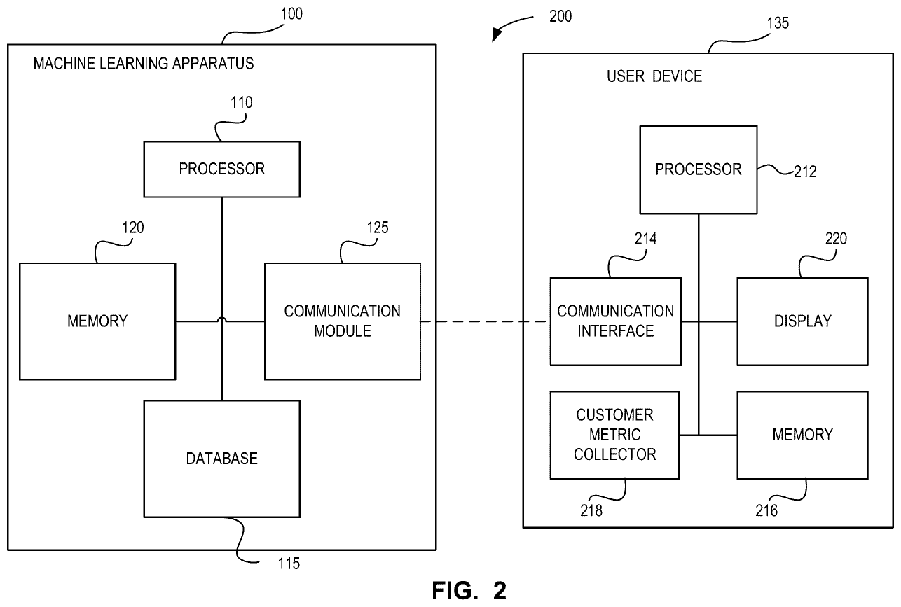

Referring to FIG. 2, FIG. 2 provides a block diagram 200 of a machine learning apparatus 100 in communication with a user device 135. The machine learning apparatus 100 can comprise a processor 110 in communication with database 115, memory 120 and communication module 125. The machine learning apparatus 100 is in communication with user device 135. The user device 135 may store in the memory 216, a set of customer metrics, collected using the customer metric collector 218. In another embodiment, the memory 120, in communication with the processor 100 may store the customer metrics. In a further embodiment, the customer metrics may be stored partially on memory 120 associated with the customer device, and partially on memory 216, associated with the processor. The customer metrics can be communicated to the machine learning apparatus 100 to train the model. The customer metrics can be sent to the machine learning apparatus in near-real time or in real-time.

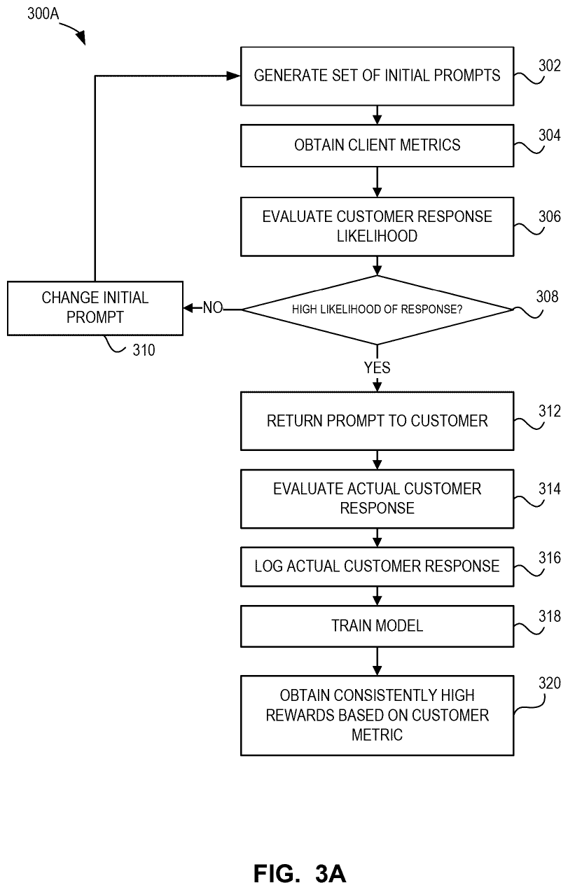

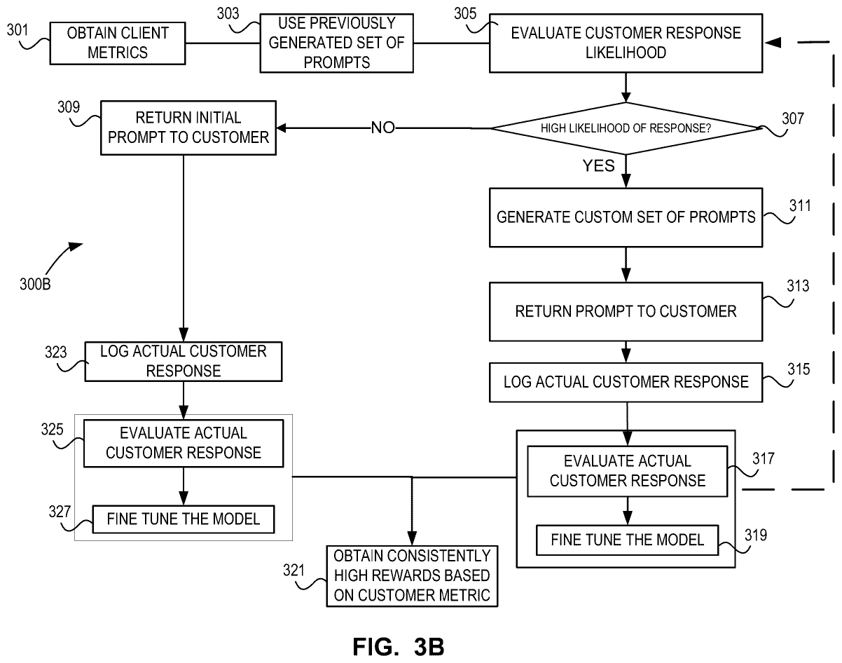

Referring to FIG. 3A, FIG. 3A provides a flowchart providing an example embodiment of a method of training a machine learning algorithm for interacting with customers using a chatbot. At 302, a plurality of messages can be generated. The plurality of messages can include at least one initial prompt, or a set of initial prompts. In one embodiment, the plurality of messages can be user generated. In another embodiment, the plurality of messages can be generated using artificial intelligence, such as, for example, using a natural language model or large language model.

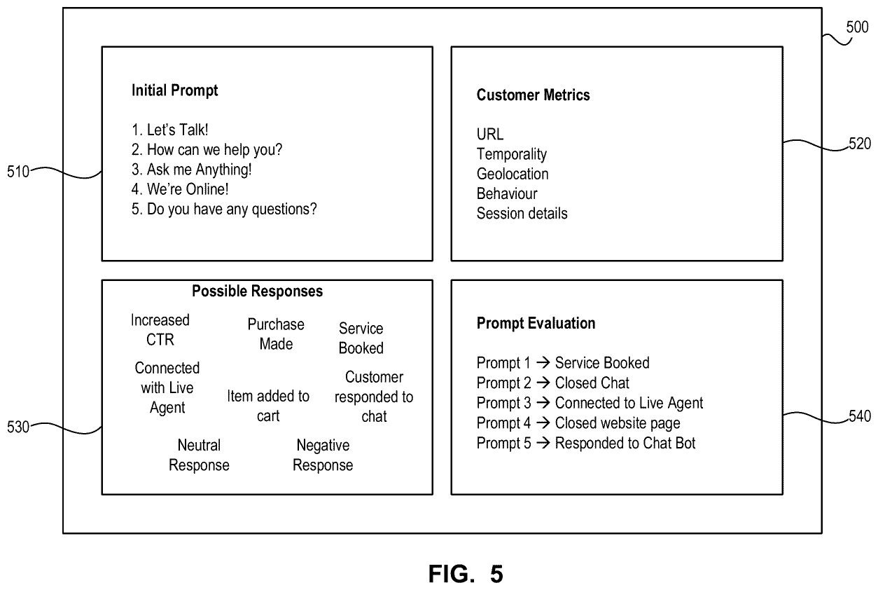

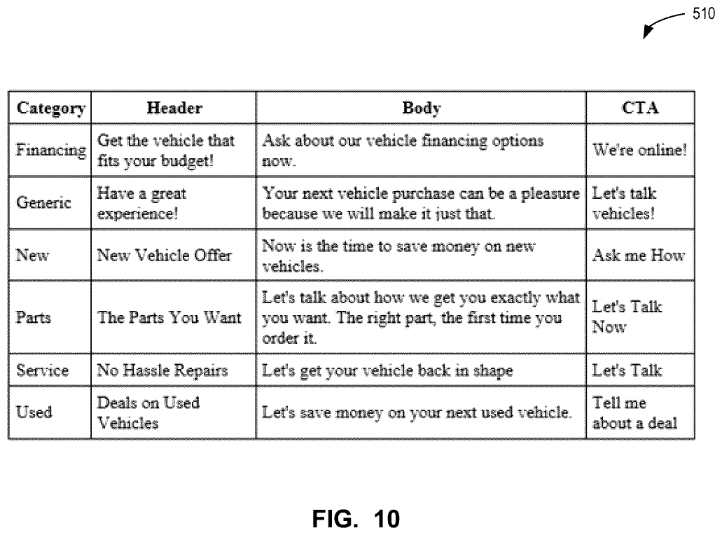

During the training phase of the machine learning model, the user can select a set of prompts to be tested. In another embodiment, the processor can determine a set of prompts to be tested. It can be understood that “set” refers to at least two prompts. The initial set of prompts can be arbitrary, or may be chosen such that but ideally are chosen to increase a reward. A sample set of initial prompts 510 is shown in FIG. 5 and FIG. 10.

In one embodiment, the initial prompt can be chosen such that the prompt is likely to increase a reward. Rewards can include positive interactions such as connecting with a live-agent, making a purchase, adding a product to a virtual shopping cart, or any other positive interaction.

At 304, the customer metrics can be communicated to the machine learning apparatus 100 to train the model. The customer metric collector 218 can be a part of the user device 135 and the metrics may be stored on the user device memory 216.

At 306, using the input initial prompts and the customer metrics, the processor 110 can evaluate the likelihood that a customer with the given set of metrics would respond to the initial prompt. At 312, If the likelihood of response is high, the prompt is returned to the customer 140, using the chatbot 130. The actual customer response is evaluated at 314 and returned to the processor 110 and the model is further trained.

At 316, the actual customer response is logged. At 318, the ML model is trained based on the customer response that was logged at 316, along with any historical data, or real-time data. In at least one embodiment, the model can be trained for any number of visitors at each visit. In at least one embodiment, the model can be trained for every other visitor, or every 5th visitor, or any other number of visitors. In at least one embodiment, training for the model can be done based on any cadence. At 320, as the model is trained, consistently high rewards can be obtained based on the customer metrics.

If the likelihood of response is low (see at 310), the initial prompt is changed, and a new prompt is generated for testing. The set of prompts is tested for each customer metric until consistently high rewards are received for each customer metric. In at least one embodiment, changing the initial prompt can be done manually or in an automatic manner based on a prompted generated by the machine learning algorithm, or a subsequent prompt needed to be tested.

Turning now to FIG. 3B, provided therein is a flowchart 300B of another example method of interacting with customers using a chatbot, in accordance with an example embodiment. In the embodiment shown in FIG. 3B, client metrics are obtained at step 301. The customer metrics can be communicated to the machine learning apparatus 100 to train the model. The customer metric collector 218 can be a part of the user device 135 and the metrics may be stored on the user device memory 216.

At 303, the model uses a previously generated set of prompts to train the ML model. The previously generated set of prompts can include at least one initial prompt, or a set of initial prompts. In one embodiment, the plurality of previously generated set of prompts can be generated previously by a user. In another embodiment, the plurality of messages can be previously generated using artificial intelligence, such as, for example, using a natural language model or large language model. The initial set of prompts can be arbitrary, or may be chosen such that but ideally are chosen to increase a reward.

At 305, using the previously generated set of prompts and the customer metrics, the processor 110 can evaluate the likelihood that a customer with the given set of metrics would respond to the previously generated set of prompts. At 307, If the likelihood of response is high, the processor can generate a custom set of prompts at 311. At 313, the custom set of prompts can be returned to the customer 140, using the chatbot 130. The actual customer response is logged at 315, evaluated at 317, and returned to the processor 110 and the model is further trained at 319. In at least one embodiment, the actual customer response 317 and the fine-tuned model are returned to the processor at 305 to refine and further train the model to generate prompts which have a high likelihood of response 307.

In at least one embodiment, if the likelihood of response is low (see at 309), the initial prompt is returned, the actual customer response is logged at 323, evaluated at 325, and returned to the processor 110 and the model is further trained at 327. In at least one embodiment, if none of the prompt options provide a high likelihood of response, no prompt is sent to the customer, and the customer may not receive a “nudge” from the processor.

The set of prompts is tested for each customer metric until consistently high rewards are received for each customer metric at 321. In at least one embodiment, changing the initial prompt can be done manually or in an automatic manner based on a prompted generated by the machine learning algorithm, or a subsequent prompt needed to be tested.

In at least one scenario, the model is need not be retrained or fine-tuned for each customer. Instead, for example, the model can be retrained every week, or every month, or at any specified interval, with enough data from the site visitors. As such, the feedback loop in place will improve the model based on successful prompts captured.

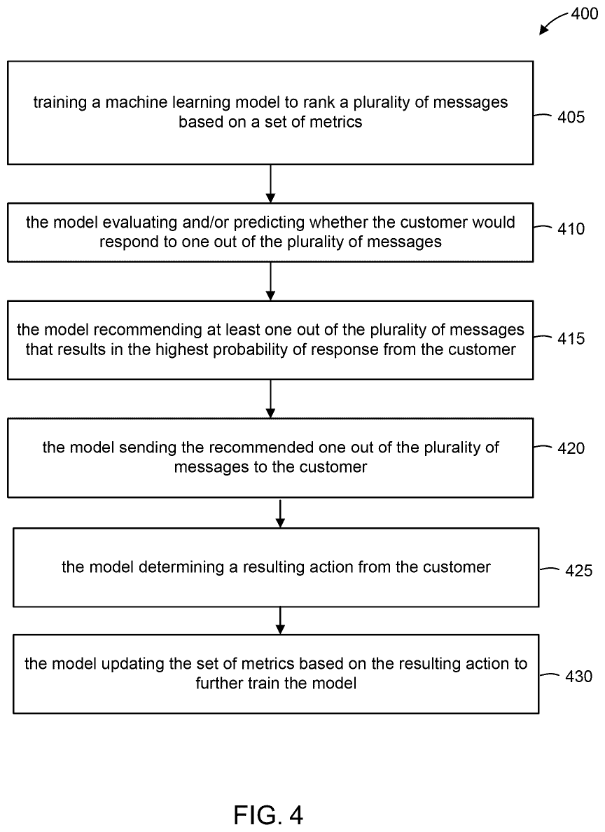

Referring to FIG. 4, FIG. 4 provides a flowchart of an example method of interacting with customers using a chatbot, in accordance with an example embodiment. The method 400 includes: at 405, training a machine learning model to rank a plurality of messages based on a set of metrics; at 410, the model evaluating and/or predicting whether the customer would respond to one out of the plurality of messages; at 415, the model recommending at least one out of the plurality of messages that results in the highest probability of response from the customer; at 420, the model sending the recommended one out of the plurality of messages to the customer; at 425, the model determining a resulting action from the customer; and at 430, the model updating the set of metrics based on the resulting action to further train the model.

The machine-learning model can use historical and real-time data such as customer metrics to rank messages or prompts based on which prompt is most likely to trigger a response from the customer. The machine learning model can be trained with historical data, real-time data, or any combination thereof. In one embodiment, the epsilon-greedy algorithm may be used to rank the plurality of messages. The epsilon-greedy algorithm provides a strategy for choosing actions in a reinforcement learning algorithm. The method comprises balancing exploration of actions and exploitation of actions by selecting the best known action having a probability of (1−ε) and a random action having a probability of ε.

The epsilon greedy algorithm can comprise: the processor choosing between exploring a new input prompt or exploiting the current best input prompt; the processor may then select a random prompt, regardless of its current probability value. The processor may then select the prompt with the highest estimated probability value, based on its past experience.

In one embodiment, the value of ε is typically set to a small value, such as 0.1 or 0.01, to encourage the model to explore new prompts while still exploiting the current best prompt.

In one embodiment, the epsilon-greedy algorithm can be used in reinforcement learning. In another embodiment, another suitable reinforcement learning algorithm may be used. For example, other suitable reinforcement learning algorithms may include, but are not limited to, the upper confidence bound (UCB) algorithm, contextual bandit, or Thompson sampling.

The training of the machine learning model can be completed using a suitable algorithm, for example, and not limited to at least one of: inverse propensity-scoring algorithm; doubly robust algorithm; and importance weighted regression algorithm.

In one embodiment, the inverse propensity scoring algorithm can be used for causal inference and treatment evaluation. In one embodiment, the inverse propensity scoring algorithm can be used to estimate the average treatment effect (ATE) in observational studies where treatment assignment is not randomized.

In another embodiment, the importance weighted regression algorithm can be used in causal inference and treatment evaluation to train the machine learning algorithm. Importance weighted regression algorithm is a generalization of the inverse propensity scoring algorithm that allows for estimating the conditional average treatment effect (CATE).

In another embodiment, the doubly robust algorithm can be used for causal inference and treatment evaluation. The doubly robust algorithm can comprise a combination of the propensity score weighting and outcome modeling approaches, and can provide an alternative way to adjust for selection bias.

Additionally, the algorithm can spend a predefined percentage of time (or requests) performing exploration or exploitation. In exploitation, the model can send the same message to the same customer, as this message has historically worked to engage the customer. In exploration, the model can try a new message to determine if a better message having a better response rate, or click-through rate can be used.

In one embodiment, the model can evaluate positive (click message), negative (close message), or neutral (ignored message/no action) actions. In another embodiment, the model can include a more detailed breakdown of positive actions and weight them.

In one embodiment, the model may change the reward, or outcome of the action based on a specific industry. For example, in a particular industry, a particular reward may be weighed higher than another reward. In one embodiment, the reward that is ideal for a given industry may be utilized to train the model; whether that be a click, a human interaction, a lead, a sale, or any other suitable reward.

Other forms of click through rate may be defined, and other CTR rewards can be acceptable; such as customer makes a purchase, customer responds on chat, customer adds item to cart, and/or, customer books service. The rewards may be equally measured or be weighted and/or ranked, for example, i.e. in one embodiment, a customer making a purchase may be valued more than simply adding an item to cart.

The plurality of messages can be stored in the database and tested for optimal response rate by the processor. The plurality of messages are input into the processor and the processor can then test & rank them based on optimal response rate. The testing and ranking may be an iterative process such that new messages may be generated, tested and ranked against the current messages.

For any given customer, there may be multiple iterations of points of contact. For example, in one embodiment, if customer A does not respond to a “Hello” prompt, the processor can be configured to send another prompt in a suitable time frame. In this instance, as the customer responded negatively to the prompt, the model can attempt to find a new prompt that may work more positively. This can occur whether the model is in exploration or exploitation, as a negative response was received. In another embodiment, the model may only provide a first prompt for each customer session, or for each visit to the website, per customer. In this embodiment, the model may not send another prompt to the same customer in the same session. However, if the customer returns in a subsequent session, the model can try a new prompt.

The training for the model consists of incrementally adding to the existing training data any new information that is available (i.e. new data about messages sent vs response since the last training) and then retraining the model on the entire new training dataset. The method can further include the step of amending at least one of the plurality of messages if the message receives a low probability of response from the customer.

Referring to FIG. 5, FIG. 5 provides a block diagram of the inputs of an example machine learning training model. In one embodiment, the inputs for the machine learning model can include a set of metrics 520 which contain information about the e-commerce platform, information about the customer; and information about the customer browsing session. The set of metrics can further include information about browsing behavior; recurrency; provenance;

geolocation; temporal details; device details and browser details. In at least one embodiment, the set of metrics further includes message timing, i.e., time between the user accessing the page and the message being displayed to the user; time between message sent and received, and other measurable amounts of time for reply. The set of metrics can also include factors such as the look of a message, including but not limited to, the font, font size, colour, bold, italics, underline, and other visual aspects of the message.

The inputs for the machine learning model can also include a set of initial prompts 510. The initial set of prompts 510 can be arbitrary, but ideally are chosen to increase a reward. For example, the initial prompts 510 can include, but are not limited to, “Let's Talk!”, “How can we help you?”, “Ask me Anything!”, “We're Online”, and “Do you have any questions?”. The plurality of messages can include a text-based prompt; voice-based prompt; image based prompt; or video based prompt. FIG. 10 provides a table showing a set of sample initial prompts that can be used as inputs to train the machine learning model.

Possible responses 530 may also be used to train the model. For example, the possible responses from the customer may include, but are not limited to, increasing click-through-rate (CTR), making a purchase, booking a service, connecting to a live-agent, adding an item to a virtual cart, responding to the chatbot, declining the message, closing the message, accepting the message, ignoring the message, closing the website or app, filling out a form, and/or completing an application.

When the actual customer response is evaluated at 340, the response is returned to the processor 110 as an input 540 and the model is further trained. For example, using the prompts 1-5 listed in 510, the customer responses are recorded, and it can be determined that prompt 1 “Let's talk!” resulted in the customer booking a service; whereas prompt 2 “How can be help you?” resulted in the customer closing the chat. Therefore, the model would learn that the customer given prompt 2, did not respond positively to the prompt, whereas the customer given prompt 1 responded positively to the prompt.

Rewards can include positive interactions such as connecting with a live-agent, making a purchase, adding a product to a virtual shopping cart, or any other positive interaction. The resulting action from the customer can be a positive action such that the customer accepts the message. The resulting action from the customer can be a negative action such that the customer declines the message. The resulting action from the customer can be a neutral action such that the customer ignores the message.

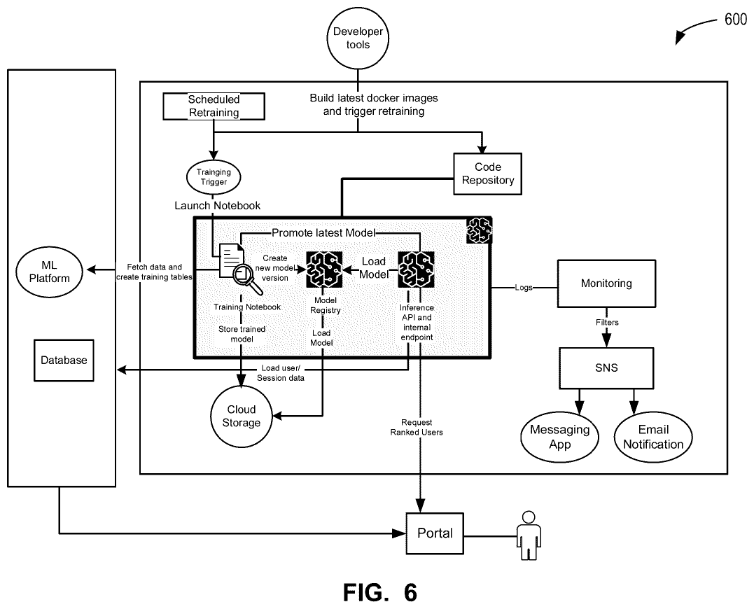

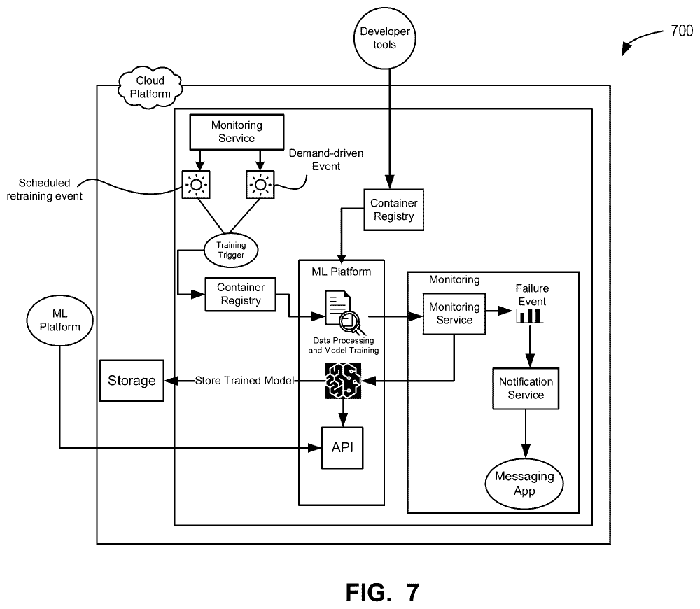

Referring to FIG. 6, FIG. 6 provides a system diagram of an example embodiment of the machine learning model. Referring to FIG. 7, FIG. 7 provides a system diagram of another example embodiment of the machine learning model.

FIGS. 6 and 7 both describe the infrastructure for the AI models. FIG. 6 describes the setup for the intent-scoring model, and FIG. 7 describes the setup for our Message Recommender model.

The infrastructure setup of the models comprise: on a schedule, the model performs ETL (Extract, Transform, Load) of data and undergoes training; The trained model is then made available through an API; The application calls the API to retrieve information about what to display to the user (intent-score for agent, or recommended message for guest) and the user takes some action; On next schedule, model is retrained with new data from step 3.

FIG. 7 provides an alternative on-demand training which allows for faster updates to the model (for example, every 15 mins instead of every day), providing for an adaptive model.

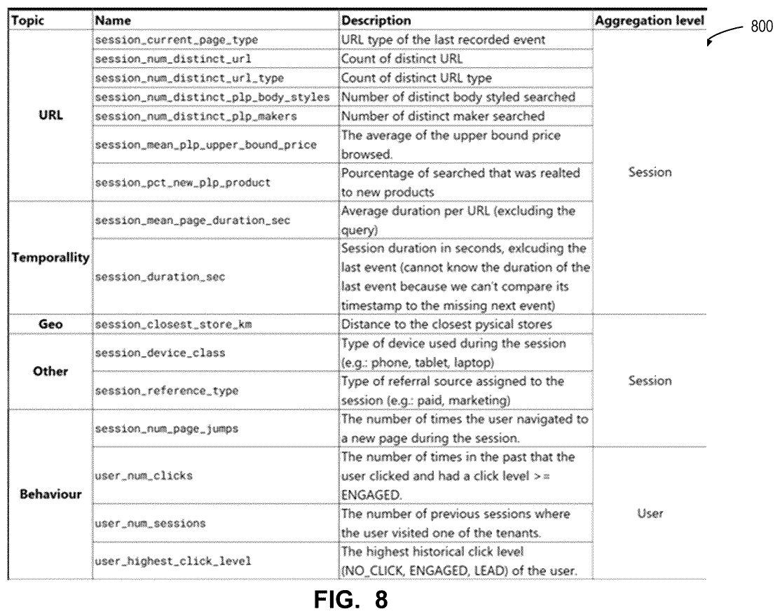

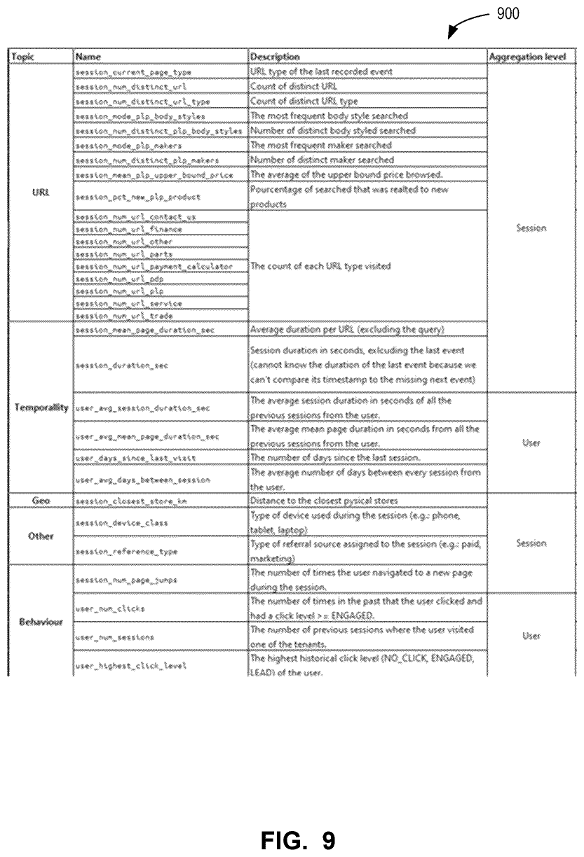

Referring to FIG. 8, FIG. 8 provides a table showing an example set of measurable customer metrics that can be used as inputs to train the machine learning model. FIG. 9 provides a table showing an alternative example set of measurable customer metrics that can be used as inputs to train the machine learning model. The table represents the set of features describing the users. This includes, but is not limited to, browsing behavior, recurrency, provenance, geolocation and temporal details.

The initial prompt language can be pre-decided or generated by the AI model. For instance, the initial prompt language can be human generated inputs but in other embodiments, it may leverage natural language processing models such as ChatGPT.

In one embodiment, once the customer accepts the nudge the customer may receive a subsequent prompt. The subsequent prompt may be pre-decided by a user or generated by the AI model. For instance, the subsequent prompt language can be human generated inputs but in other embodiments, it may leverage natural language processing models such as ChatGPT.

In another embodiment, once a customer accepts a nudge, the customer may be transferred to a live agent. In one embodiment, the customer may be sent to a virtual queue, virtual waiting area or bot before being transferred to a live agent. In one embodiment, a machine learning algorithm or natural language processing model may be coupled to the chat box to assist the customer and answer customer questions. The possible responses from the customer may include, but are not limited to, increasing click-through-rate (CTR), making a purchase, booking a service, connecting to a live-agent, adding an item to a virtual cart, responding to the chatbot, declining the message, closing the message, accepting the message, ignoring the message, closing the website or app, filling out a form, and/or completing an application.

In one embodiment, an algorithm to generate the most optimal “initial prompt” for online sales chat systems is taught herein. Use of epsilon greedy algorithm can be used for solving multi-armed bandit problems.

FIGS. 8 and 9 comprise a list of the customer profile-based metrics. The customer metrics may be used to determine the most optimal initial prompt and any subsequent prompts. In one embodiment, there are a plurality of data inputs. In another embodiment, the plurality of data inputs may comprise 31 individual inputs.

The customer metrics can be based on the set of features including temporality, geolocation, behavioral, and browsing history (FIG. 8, FIG. 9). Based on this information, the model periodically (i.e. during retraining) learns whether similar customer profiles reacted positively or negatively to certain messages and adjusts its recommendation if necessary (for the next similar customer).

The model can use a unique identifier for each customer, which may be referred to as a domain userID. The domain userID can be used to build the customer profile based on the feature set shown in FIG. 8. In one embodiment, the customer log-in or other client-provided information can be used to identify the customer. In another embodiment, the IP address of the customer may be used to identify the customer. As such, it can be possible to identify the customer and generate prompts which may be the most suitable for a given customer.

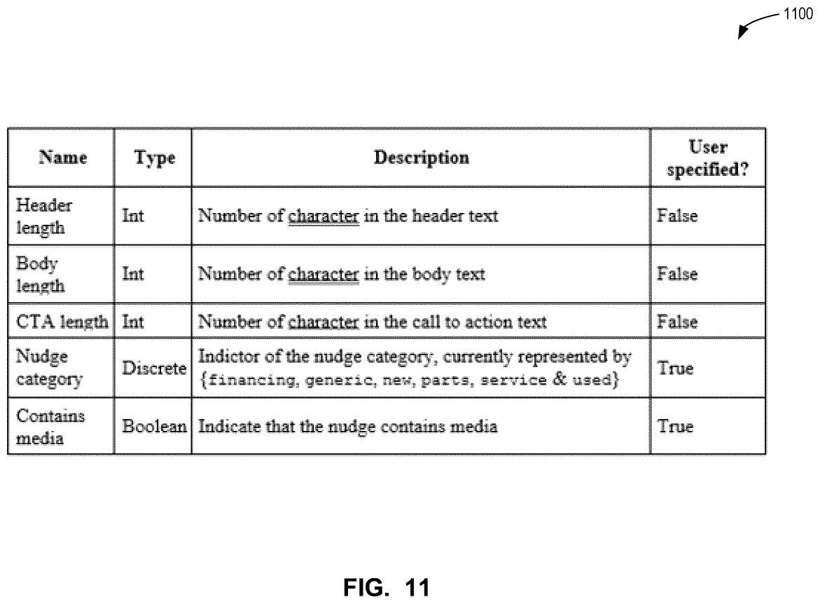

The model, using a contextual bandit algorithm, can allow for action-dependent features through the choice of any feature map. FIG. 11 provides an example set of implemented features to better describe actions and ideally reduce the cold start problem of future actions. These features aim to be general enough to be robust to new variations of nudges.

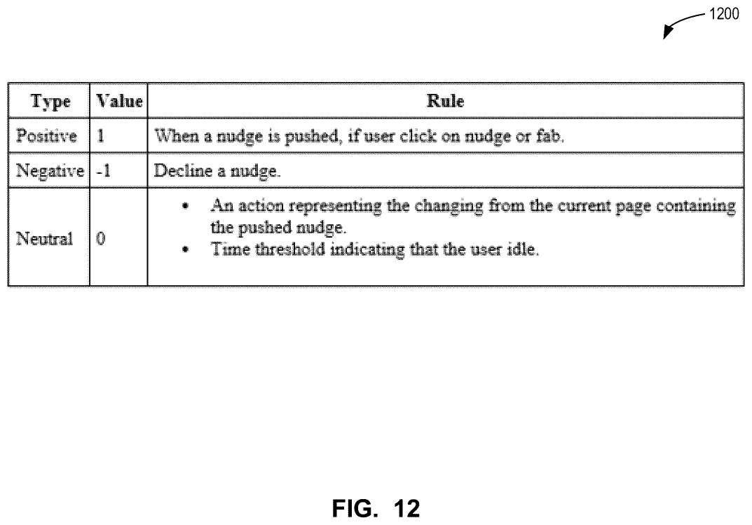

FIG. 12 provides a sample list of possible rewards 1200. In one embodiment, the model can evaluate positive (click message), negative (close message), or neutral (ignored message/no action) actions. In another embodiment, the model can include a more detailed breakdown of positive actions and weight them.

In one embodiment, the model may change the reward, or outcome of the action based on a specific industry. For example, in a particular industry, a particular reward may be weighed higher than another reward. In one embodiment, the reward that is ideal for a given industry may be utilized to train the model; whether that be a click, a human interaction, a lead, a sale, or any other suitable reward.

Other forms of click through rate may be defined, and other CTR rewards can be acceptable; such as customer makes a purchase, customer responds on chat, customer adds item to cart, and/or, customer books service.

The possible responses from the customer may include, but are not limited to, increasing click-through-rate (CTR), making a purchase, booking a service, connecting to a live-agent, adding an item to a virtual cart, responding to the chatbot, declining the message, closing the message, accepting the message, ignoring the message, closing the website or app, filling out a form, and/or completing an application. The rewards may be equally measured or be weighted and/or ranked, for example, i.e. in one embodiment, a customer making a purchase may be valued more than simply adding an item to cart.

For example, on a coffee ordering app, a customer orders the same coffee order daily. On the first day, the customer may receive a prompt “What can I get started for you?” The customer can type their coffee order and place order through the app. This may be recorded as a positive CTR. On a second day, the customer wishes to order their coffee using the same app. If the processor is in exploitation, the customer may receive the same prompt “What can I get started for you?” as this previously resulted in a positive CTR. If the processor is in exploration, the customer may receive a new prompt, such as “Would you like to order a coffee?”. In another embodiment, the customer may receive a custom-generated prompt such as “Hello Mary, would you like to order a small coffee with milk and sugar?” The results of the new prompts can be recorded as being positive, negative or neutral CTR. In another embodiment, the customer may respond to a message about iced coffee in the summer time, but as the weather gets colder, the model can switch away from iced drinks and move to hot drinks. In exploitation, it would continue to send the iced coffee prompt, but with exploration, the prompt can be switched for a customer that has previously positively responded to the iced coffee message, and the model can learn that hot coffee may now be a better prompt.

The plurality of messages can be stored in the database and tested for optimal response rate by the processor. The plurality of messages are input into the processor and the processor can then test & rank them based on optimal response rate. The testing and ranking may be an iterative process such that new messages may be generated, tested and ranked against the current messages.

For any given customer, there may be multiple iterations of points of contact. For example, in one embodiment, if customer A does not respond to a “Hello” prompt, the processor can be configured to send another prompt in a suitable time frame. In this instance, as the customer responded negatively to the prompt, the model can attempt to find a new prompt that may work more positively. This can occur whether the model is in exploration or exploitation, as a negative response was received. In another embodiment, the model may only provide a first prompt for each customer session, or for each visit to the website, per customer. In this embodiment, the model may not send another prompt to the same customer in the same session. However, if the customer returns in a subsequent session, the model can try a new prompt.

The machine-learning model can use historical and real-time data such as customer metrics to rank messages or prompts based on which prompt is most likely to trigger a response from the customer. The machine learning model can be trained with historical data, real-time data, or any combination thereof. The machine learning model ranks the plurality set of messages based on likelihood to result in engagement from the customer and increases the number of inbound calls to the agents. The AI model can be trained on historical browsing metrics on all clients within a given vertical (for example, automotive). For every live customer, the model periodically (for example, every 5 seconds) evaluates whether this customer would respond to one of a set of messages. If the likelihood of responding is high, the model returns that message which is then displayed to the customer. The customer's response (or lack thereof) to the message is fed back into the AI model as it is retrained. In one embodiment, the model can also explore, in real-time, alternative messages and evaluates their performance so that it can capture trends or changes in trends over time. AI model can then recommend and send the prompt best suited for the customer.

In an alternative embodiment, the AI model can be used to rank any text-based inputs against one another. For instance, the AI model can be used to rank titles of videos such as YouTube™ videos, or titles of songs, movies, books or other multimedia content to determine which title from a plurality of titles generates the highest click-through rate.

In another embodiment, the model may be used to rank online newspaper headlines or news channel headlines to determine which headline from a plurality of headlines generates the highest click-through rate.

In yet another embodiment, audio clips, or voiceover clips, or other forms of voice-based media may be converted to text-based inputs to be used as initial prompts.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims.

1. A method of interacting with a customer on an e-commerce platform, the method comprising:
providing, by a processor, a model to rank a plurality of messages based on a set of metrics;
evaluating, by the processor, whether the customer would respond to one out of the plurality of messages;
recommending, by the processor, at least one out of the plurality of messages that results in the highest probability of response from the customer;
sending, by the processor, the recommended one out of the plurality of messages to the customer;
determining, by the processor, a resulting action from the customer; and
updating, by the processor, the set of metrics based on the resulting action to further train the model.

2. The method of claim 1, wherein said model is a machine learning model.

3. The method of claim 2, wherein the set of metrics contains information about the e-commerce platform, information about the customer; and information about the customer browsing session.

4. The method of claim 3, wherein the training of the machine learning model is completed using at least one of: inverse propensity-scoring algorithm; doubly robust algorithm; and importance weighted regression algorithm.

5. The method of claim 4, wherein the method further comprises the step of amending at least one of the plurality of messages if the message receives a low probability of response from the customer.

6. The method of claim 5, wherein the plurality of messages comprises a text-based prompt; voice-based prompt; image based prompt; or video based prompt.

7. The method of claim 6, wherein the set of metrics further comprises information about browsing behavior; recurrency; provenance; geolocation; and temporal details.

8. The method of claim 7, wherein the resulting action from the customer is a positive action such that the customer accepts the message.

9. The method of claim 8, wherein the resulting action from the customer is a negative action such that the customer declines the message.

10. The method of claim 9, wherein the resulting action from the customer is a neutral action such that the customer ignores the message.

11. An apparatus, comprising: a memory for storing instructions; and
a processor configured to execute the instructions and thereby cause the apparatus to at least:
provide a model to rank a plurality of messages based on a set of metrics;
evaluate and/or predict whether the customer would respond to one out of the plurality of messages;
recommend at least one out of the plurality of messages that results in the highest probability of response from the customer;
send, via an interface, the recommended one out of the plurality of messages to the customer; said interface being adapted to display the message;
determine a resulting action from the customer; and
update the set of metrics based on the resulting action to further train the model.

12. The apparatus of claim 11, wherein said model is a machine learning model.

13. The apparatus of claim 12, wherein the set of metrics contains information about the e-commerce platform, information about the customer; and information about the customer browsing session.

14. The apparatus of claim 13, wherein the training of the machine learning model is completed using at least one of: inverse propensity-scoring algorithm; doubly robust algorithm; and importance weighted regression algorithm.

15. The apparatus of claim 14, wherein the method further comprises the step of amending at least one of the plurality of messages if the message receives a low probability of response from the customer.

16. The apparatus of claim 15, wherein the plurality of messages comprises a text-based prompt; voice-based prompt; image based prompt; or video based prompt.

17. The apparatus of claim 16, wherein the set of metrics further comprises information about browsing behavior; recurrency; provenance; geolocation; and
temporal details.

18. The apparatus of claim 17, wherein the resulting action from the customer is a positive action such that the customer accepts the message.

19. The apparatus of claim 18, wherein the resulting action from the customer is a negative action such that the customer declines the message.

20. The apparatus of claim 19, wherein the resulting action from the customer is a neutral action such that the customer ignores the message.

21. A method of interacting with a customer on an e-commerce platform, the method comprising:
generating, by a processor, a plurality of messages based on a set of metrics associated with the customer;
evaluating, by the processor, whether the customer would respond to one out of the plurality of messages;
recommending, by the processor, at least one out of the plurality of messages that results in the highest probability of response from the customer;
sending, by the processor, the recommended one out of the plurality of messages to the customer;
evaluating, by the processor, a resulting action from the customer;
logging a record of the resulting action into a memory; and
updating, by the processor, the set of metrics based on the resulting action to further train the model.
